(19) United States
(12) Patent Application Publication
(10) Pub. No.: US 2021/0150824 A1
(43) Pub. Date: May 20, 2021

(54) A method of collecting travel fares in a transport system

(71) Applicant: Anil Goel, London (GB)

(72) Inventor: Anil Goel, London (GB)

(21) Appl. No.: 17/047,288

(22) PCT Filed: Apr. 11, 2019
(86) PCT No.: PCT/EP2019/059333

§ 371 Date: Oct. 13, 2020

(30) Foreign Application Priority Data
Apr. 13, 2018 (GB) 1806070.7

(51) Int. Cl. G07B 15/04; G06Q 30/02; G07C 9/10; G06Q 20/28; G06Q 20/32; G07C 9/38; G06Q 50/26; G06Q 30/00; G06Q 20/40; G06K 7/14; G06K 7/10; G06F 8/61

(52) U.S. Cl. CPC G07B 15/04; G10L 15/22; G07C 9/10; G06Q 20/28; G06Q 20/326; G06Q 20/3229; G07C 9/38; G06Q 50/265; G06Q 30/0185; G06Q 20/4037; G06Q 20/3274; G06K 7/1413; G06K 7/1095; G06F 8/61; G06Q 2240/00; G06Q 30/0284

(57) ABSTRACT

For electronic fare collection, an APP is downloaded onto a smartphone for automatic payment for transit fare. Upon successful registration of funds onto the APP an associated server system issues a fund indicator to the APP. Upon machine-reading the fund indicator by the validation terminal at the entry and exit gates in the transit station, the application server system calculates the transit fare and reissues the fund indicator with balance funds available after deducting the transit fare to the computer application module (APP). Indication of sufficient funds when scanned at the entry gate allows entry of the passenger through the entry gate. During the passenger's travel, the correctness of the funds is checked and a top up of insufficient funds requested before exiting through the exit gate.

### FIELD OF THE INVENTION

The present invention relates generally to online fare collection and operation, and more specifically, to systems and methods for operating an electronic fare collection for public transit system.

### BACKGROUND OF THE INVENTION

There are already existing methods of fare collection implemented by public transit operators. The most common method is so-called “closed-loop cards” that are used specifically for fare collection, for example Oyster® card system of transport for London in UK. The closed loop card can be registered with funds by cash at ticket counter or at AVM (Add Value Machine). The funds can also be registered online into the user account but the passenger still need to present the physical card after sometime for example 30 minutes at the AVM/ticketing machine to collect the funds on the card. The fares are collected by fare payment terminals for example a radio frequency identification (RFID) card reader, which are installed at entry gates, exit gates or within service zones. These terminals calculate fare payments and validate the passenger's access to services. The payment terminals are hereafter collectively called “validation terminals”. The entry-registration is typically originated when a passenger presents the card to a validation terminal at the beginning of a trip, for example, at the entry gate to a transit station or when boarding a bus or train. The exit-registration is typically originated when a passenger presents the card to a validation terminal at the end of a trip. Exit-registration is commonly used by transit systems where the fare depends on the distance travelled (so called distance-based or zone-based fare systems). The incomplete registration is typically originated when a passenger does not present the card to a validation terminal at then end of a trip. This may also be due to out of service/faulty validation terminal. Penalty fare is commonly charged for incomplete registration for example maximum fare of the transit system. The transfer registration is typically originated when a passenger transfers from one route to another, one vehicle to another or one transit entity to another transit entity participating in the same fare collection system. A transfer registration may sometimes be a variation of an entry-registration or complementary to a entry-registration.

An inspection activity may be implemented in some transit systems to verify the validity of a combination of a fare and trip. An inspection activity is typically originated when a card is presented to an inspection validation terminal that may be carried by fare-enforcement staff during any phase of a trip.

The entry gates and exit gates are commonly barricaded which open only after validation i.e. entry-registration and exit-registration respectively. The entry and exit gates may sometimes remain open at certain times during high human traffic for example during peak hours but validation is compulsory i.e. entry-registration and exit-registration. Currently Delhi Metro is piloting an open entry and exit gates, wherein the barricade closes only if the passenger does not validate at the validation terminal to increase the throughput. The entry gates and exit gates may not have any barricade to enter or exit the service for example Mumbai suburban railways.

There are many problems with closed loop system,

1) the cost of such card has to be borne by the passenger,
2) the card can be lost and hence the funds registered on the card and
3) the passenger cannot view the funds available on the cards which causes unnecessary delay/disruption due to denial of service as a result to insufficient funds on the card unknown to the passenger and also the passenger may not know the penalty fare/overcharge until later date.

Recently, some transit operators also accept open loop payment schemes, such as accepting EMV (Europay, Mastercard, and Visa) contactless credit and debit cards. Open-loop fare collection systems have certain advantages. For example, passengers already having open-loop cards do not need to acquire additional, closed-loop cards and replenish them with funds before they start using a transit system.

Open loop fare systems sustain numerous problems, especially when vehicle installed fare payment terminals (validation terminals) are used for open loop payments. The problems are aggravated by the wide diversity of payment card types including smart (EMV) cards, and payment networks.

US2016/0240016 by Ranpour discloses a transportation system that has a fixed or variable fare system with multiple entry and exit points in data connection with a server at which the fare is calculated in dependence on a user's journey. To enter and exit the transport system, a user scans a code displayed on their mobile computing device which contains their user ID where funds can be added to a user account either via a software application on the mobile communications device or on a website, where the server keeps a record of the available funds.

US2016/0240016 illustrates a typical prior art teaching of checking actual available funds by communication to a central server at the entry gate and exit gate. However, this implies a delay in the passengers' entry and exit due to verification procedure of actual available funds and hence prevents smooth flow of passengers through the transportation system.

Other examples of electronic payment control systems at entry gates are disclosed in CN106296176 and CN106296293 by Chengdu Rentong Fusion Information Tech.

According there exist a need for means to bring a more universal fare collection method which is convenient, transparent, secure, efficient, cost effective, user and environment friendly.

### SUMMARY OF THE INVENTION

In view of the foregoing shortcomings inherent in the closed and open loop card system for fare collection and/or operation, the general purpose of the present invention is to provide an optimum combination of convenience, utility and cost, to include the advantages of the prior art, and to overcome the drawbacks inherent therein. This purpose is achieved with a method and system as explained in more detail below. The present invention provides methods for electronic fare collection which is convenient, secure, efficient, cost effective, user and environment friendly.

In short, the invention comprises the following method for smooth and quick passenger flow through a transport system: For such electronic fare collection, a computer application, APP is downloaded by a passenger onto a smartphone for automatic payment of transit fares. Upon successful registration of funds onto the APP, an associated server system issues a fund indicator to the APP. Upon machine-reading the fund indicator by the validation terminal at the entry and exit gates in the transit station, the application server system calculates the transit fare and reissues the fund indicator with balance funds available after deducting the transit fare to the computer application APP.

In contrast to prior art method and systems, indication of funds by the indicator, where the funds are above a predetermined threshold as scanned at the entry gate, is sufficient for entry of the passenger through the entry gate. The verification of correctness of the indicated funds and the actual funds available for the travel is only made after the passenger's entry through the entry gate. Relying merely on the fund indicator for a passenger's entry into the transport system results in a fast and smooth entry procedure, which is necessary for high throughput of passengers. For assuring such smooth passenger flow through the entry gate, the method accepts a potentially false indication on the indicator for example due to an un-updated fund indicator. However, as the time of the travel is generally long enough to get the passenger informed about false indication or any irregularity, especially missing funds and for passenger to add more funds if the actual funds are below threshold before exiting the transport system, and does not affect the flow of other passengers through the transport system.

Details are explained below.

The method for collecting travel fares is designed for a transport system according to the following. The transport system is typically a train transport system, for example underground train system or tram system or combinations of various train systems. However, the system is also useful for bus systems and any combination thereof.

The transport system comprises multiple departure locations with multiple destinations and with a variable fare system in which a fare is dependent on the distance between a departure location and a destination. Each departure location comprises an entry gate system with at least one entry gate and at least one local entry computer, and each destination comprises an exit gate system with at least one exit gate and at least one local exit computer. Each of the entry gates is provided with entry validation terminal data-connected to the at least one local entry computer, and each of the exit gates is provided with an exit validation terminal data-connected to the at least one local exit computer. Optionally, the entry computer and the exit computer at one location are identical in that a single computer is used as entry computer and also as exit computer. The transport system is configured for registering a passenger's passage through the entry gate and exit gate by the corresponding validation terminals for calculating the fare for the distance of the passenger's travel from the departure location to the destination and charging the passenger for the fare. For the latter, the transport system comprises an application server system, which has data connection to the entry and exit computers for exchange of passenger-related data between the application server system and the entry and exit computers, in particular for controlling passenger's entry and exit from the system.

Instead of using cards for validation at the entrance and exit gates, the invention uses a mobile telephone of the user where the display of the mobile telephone displays a fund indicator, for example in the form of a barcode, such as QR® code, Aztec® code, proprietary code etc. which is then read by the validation terminals in order for the passenger being allowed to enter and exit the system. The fund indicator is replaced by a new fund indicator on the mobile telephone after deduction of the fare from a user account.

When the procedure is smooth, the passenger scans the fund indicator as displayed on the mobile telephone at the departure location's entry validation terminal, passes the entry gate, travels to the destination, scans the fund indicator as displayed on the mobile telephone at the destination's exit validation terminal, passes the exit gate, and receives on the telephone an updated fund indicator reflecting the remaining funds on the corresponding user account after deduction of the fare.

However, as it will be more apparent in the following, the system should be designed to minimize the risk for errors and fraud. For example, the fund indicator may not have been updated properly after the last travel, and the available funds on the user account are less than indicated on the fund indicator. Another example is an attempt for fraud, where the passenger enters the system without proper entry registration, for example by climbing over the entry gate. With these risks in mind, a proof system and method has been designed which is simple and reliable and which takes care of high throughput of passengers through entry and exit gates, as is necessary in modern train transit systems.

To properly setup the passenger's telephone for use in the system, the following procedure is used, including
providing a computer application, APP, and submitting it to at mobile telephone of the passenger and installing it, wherein the mobile telephone comprises a SIM card with a telephone number, the APP being programmed for registering prepaid funds that are available on a user account of the passenger for covering automatic collection of the fare; wherein the APP is programmed to display a machine readable fund indicator on the display of the mobile telephone, the fund indicator indicating the remaining funds on the user account;
by the application server system, which is associated with the APP, causing the APP to submit ID data of the mobile telephone, including the telephone number, from the APP to the application server system and by the application server system creating a user account and associating the ID data with the user account;
by the application server system registering collection of prepaid funds into the user account prior to collection of the fare and sending corresponding data to the APP for registration of the available prepaid funds by the APP and indicating the funds by the fund indicator.

Once, the passenger's telephone has been set up for displaying the fund indicator on the display, it can be used to enter the transport system. In this event, the method is including the following as part of the passenger's travel:
at the entry gate for the passenger, by the entry validation terminal machine-reading the fund indicator on the display of the mobile telephone as part of an entry registration of the passenger, and submitting data from the fund indicator, as machine-read at the entry gate, from the at least one entry computer to the application server system;
at the exit gate for the passenger, by the exit validation terminal machine-reading the fund indicator on the display of the mobile telephone as part of an exit registration of the passenger, and submitting data from the fund indicator, as machine-read at the exit gate, from the at least one exit computer to the application server system;
by the application server system, on the basis of the data received from the entry and exit computers, calculating a fare for the travel between the passenger's entry gate and the exit gate and deducting the fare from the available funds in the corresponding user account,
submitting data for available remaining funds in the corresponding user account from the application server system to the APP, registering the funds by the APP and on the display of the mobile telephone indicating the remaining funds by the fund indicator.

In principle, the available funds on the user account could be checked at each entry of a passenger through the entry gate. However, this would imply the necessity of data exchange between the entry computer at the entry gate and the application server system before the entry gate opens. When having large numbers of passengers entering the transport system, such data exchange is at risk to become too slow. And in the case of interruption of the data connection, there is a risk that the entry gates remain closed. This is not useful when a high throughput is desired. In a practical embodiment, the method comprises evaluating at the passenger's entry gate by the entry computer whether the fund indicator indicates funds above a predetermined threshold and allowing the passenger to pass the entry gate only in the case that the threshold is met.

In the event of the threshold not being met by the fund indicator, the passenger is prevented from passing the entry gate. In addition, the application server system is causing the APP to indicate to the passenger to register more funds in order to pass through the entry gate.

For example, the threshold is above a minimum fare for the transport system. Optionally, it is below the maximum fare for the transport system. Typically, a compromise is found for the threshold between a minimum and maximum fare.

Thus, the indication on the fund indicator meeting the threshold is sufficient for entry through the entry gate, if the indication is above a certain predetermined threshold, even in the event that the fund indicator potentially shows funds, which are not correct relatively to the actual funds available on the user account.

Relying on then fund indicator for entry into the system results in a fast entry procedure, which is important for high throughput of passengers. For assuring such smooth passenger flow through the gate, the method accepts a potentially false indication by the fund indicator for example due to an un-updated fund indicator. However, as the time of the travel is generally long enough for getting the passenger informed about false indication or any irregularity, especially missing funds, and for passenger to add more funds if the actual funds are below threshold before exiting the transport system, which does not affect the flow of other passengers through the transport system.

However, the system should also be designed to detect the passenger's that have insufficient funds on the user account, despite the fund indicator showing enough funds. Based on these considerations, the further aspect is useful. Although, the threshold was met by the indicated funds on the fund indicator, as a control measure, only after entry of the passenger through the entry gate, data are exchanged by the entry computer with the application server system for the application server system to check whether available funds on the corresponding user account as registered by the application server system do actually meet the threshold. If the funds registered as available on the corresponding user account do not meet the threshold, despite the indication of sufficient funds by the fund indicator, the associated ID data are registered in a watch list, which is submitted from the application server system to all exit computers. In addition, the application server system is causing the APP to indicate to the passenger to register more funds in order to pass through the exit gate.

Thus, if a passenger has passed the entry gate due to a wrong indication on the fund indicator, the passenger can be held back at the exit gate on the basis of the watch list. The watch list is checked by the exit computers at each passenger's exit gate for ID data for the passengers passing the exit validation terminal. The passenger's is prevented from passage through the exit gate if the watch list contains the ID data. If the passenger registers sufficient funds before passing through the exit gate, the application server system removes the ID data from the watch list, which is submitted from the application server system to all exit computers.

Two practical embodiments are explained in the following for such improved control. In both embodiments, an inspection terminal is provided with a data connection to the application server system and operated by control-personnel.

In the first practical embodiment, the inspection terminal is machine-reading the fund indicator on the telephone of the passenger and extracting the ID data, and, optionally displaying the funds from the fund indicator on a display of the inspection terminal. The ID data are then submitted to the application server system for further control, for example directly from the inspection terminal or via the exit computer.

In the second practical embodiment, it is assumed that the passenger's mobile telephone cannot display the fund indicator, for example because the telephone of the passenger is not working properly, has run out of battery or has been lost. In this case, the passenger can give the telephone number to the control-personnel, which is entered into the inspection terminal, for example manually on a keypad or touchpad of the inspection terminal or entered by voice recording with speech recognition. The telephone number is submitted to the application server system for further control, for example directly from the inspection terminal or via the exit computer.

In both practical embodiment, the application server system is then checking the available funds on the corresponding user account and checking whether the ID data have been received by the application server system from an entry computer as a confirmation of the entry-registration at an entry validation terminal at the start of the passenger's travel from a departure location. If the entry-registration cannot be confirmed, this indicates that the passenger has not properly been registered at the entry gate, for example because of an attempt of fraud.

After the check, the application server submits an indication of the available funds back to the inspection terminal as well as an entry-indication of an entry-registration or lack thereof, which is then displayed on a display of the inspection terminal. The control-personal is then checking the displaying of the available funds and the entry-indication on the display of the inspection terminal and allowing the passenger to pass the exit gate only if the indicated available funds meet a predetermined threshold and only if an entry-registration is confirmed by the entry-indication. After the passage of the passenger through the exit gate, a confirmation of the passenger's exit is submitted to the application server system as a control.

Otherwise, other actions are necessary for clarification, which are similar to actions in existing transport systems when passengers are detected for not having paid the fare properly. For example the maximum fare/penalty fare is charged for incomplete registration i.e. if the passenger does not entry-register or exit-register.

Advantageously, the inspection terminal is a hand-held device. In a practical embodiment, the inspection terminal comprises a further mobile telephone provided with an inspection computer application, INS-APP, associated with the application server system, the INS-APP being programmed for communication with the application server system and for receiving and displaying the indication of the available funds as well as the entry-indication and the fund indicator on a display of the further mobile telephone.

Due to the inspection terminal displaying the fund indicator, it can be used for exit validation instead of using the mobile telephone of the passenger. In this case, the control-personal is causing the exit validation terminal to machine-read the fund indicator as displayed on the hand held inspection terminal. If the indicated available funds meet a predetermined threshold and if an entry-registration is confirmed by the entry-indication, the passenger is allowed to pass the exit gate.

In some embodiments, a transit station application module (TSA) is associated with the application server system and installed on a transit station computer system, which is data-connected to the validation terminals at the entry and exit gates. The application server system is capable of calculating transit fare for a journey and deducting the fare from the funds registered on the user account and reissuing the fund indicator to the computer application module (APP); an inspection computer application module (INS-APP) is used to inspect the funds available, entry-registration or exit registration on the user account of the passenger by transit operator staff.

As explained above, the present invention provides an automatic payment system for transit fare from a communication device, which has been exemplified as a mobile telephone, although a tablet computer could be used as well. In more detail, the method comprises a plurality of following optional stages/steps. The communication device of a first passenger is provided with a SIM card inside having a first registered telephone number “mobilenumber1”. The computer application module (APP) is downloaded, with an appropriate APP distribution service for example PlayStore™ for Android™ and AppStore™ for iOS®, through the Internet onto the mobile telephone and installed thereon. As part of the installation procedure, the computer application module (APP) receives “mobilenumber1” from the SIM card, either automatically or by user input, and submits it to the application server system which in turn sends a SMS with an OTP (one time password) to “mobilenumber1” to verify the mobile number. On receiving the OTP by user input, the computer application module (APP) submits it automatically to the application server system. Upon successful verification of “mobilenumber1”, the application server system automatically activates a first user account. Upon activating the user account for the first telephone number, the computer application module (APP) on the mobile telephone prompts the user to type an amount of funds to be registered on the user account for automatic transit fare payments and select a payment method, for example by inserting data for a credit card or debit card. Upon user command and request, the computer application module (APP) sends the application server system the amount of funds to be registered on the user account and the selected payment method to process the payment. Upon successful payment, the application server system sends a machine readable fund indicator for example a barcode, with the amount of available funds and a transaction statement to the computer application module (APP).

Upon machine-reading the fund indicator by the validation terminal installed at an entry gate, the entry gate barricade opens for the passenger to enter the station. The transit station's computer system sends data on the fund indicator to the application server system. The application server verifies the amount on the fund indicator with the actual amount available on the user account and on successful verification sends the entry-registration notification to the computer application module (APP) and updates the transaction statement. Upon machine-reading the fund indicator by the validation terminal installed at the exit gate, the exit gate barricade opens for passenger to exit the station; the transit station's computer system sends data on the fund indicator to the application server system. The application server system calculates the transit fare for the journey undertaken by the passenger; reissues the fund indicator with balance funds available after deducting the transit fare and updates the transaction statement on computer application module (APP).

The system and method of the present invention are universal and easy-to-use for paying the transit fare.

As used herein, the term ‘plurality’ refers to the presence of more than one of the referenced item and the terms ‘a’, ‘an’, and ‘at least’ do not denote a limitation of quantity, but rather denote the presence of at least one of the referenced item.

### BRIEF DESCRIPTION OF THE DRAWINGS

The invention is exemplified in the following with reference to the drawings:

FIG. 1 is a schematic illustration of a system for electronic fare collection;

FIG. 2 is a flow chart of stages of fund-registration on the user account for an automatic payment for transit fare, receiving a machine readable fund indicator and the transaction statement;

FIG. 3 is a flow chart illustrating the stages for machine-reading the fund indicator by validation terminal at entry and exit gates at a station and automatically deducting the transit fare from the user account of the passenger.

FIG. 4 is a flow chart illustrating the stages for inspecting the user account of the passenger on the inspection computer application module (INS-APP) and exit-registering the passenger by machine-reading the fund indicator on inspection computer application module (INS-APP) by validation terminal at exit gate by transit operator staff.

### DETAILED DESCRIPTION OF THE DRAWINGS

According to an exemplary embodiment, the present invention comprises at least a backend database for data storage, Libraries and Framework for secured data transmission over the web, Frontend and Mobile App Platforms for end user.

The term ‘Smartphone’ is used herein as a mobile telephone with capabilities for Internet access and with an advanced mobile operating system that is capable of running downloaded applications, also called APPs. Examples of such advanced operating systems include iOS® for iPhone® provided by Apple®, or Android™ or Microsoft Windows. This list is not exhaustive and other operating systems capable of running downloaded applications may be adapted to implement the principal of the present invention.

The term, “transit station” is used in the following as a general term for the departure location for the travel with the entry gate and the destination with the exit gate. Potentially, it also comprises stations where a passenger changes train or changes between train and bus.

According to an exemplary embodiment, the present invention provides a simple way to automatic pay for the transit fare without the need of a physical card. The system for electronic fare collection of the present invention is more universal and versatile, mostly uses the current infrastructure and processes at transit stations, is capable of avoiding requirement of great amount of capital, new processes and long time to build the system.

The system for electronic fare collection comprises: a communication device, typically a mobile telephone, which is a smartphone, with Internet access capabilities having at least a SIM card with a registered telephone number, wherein the communication device includes a mobile telephone; a computer application module (APP) capable of being installed in the communication device for receiving an amount of funds to be registered on the user account for automatic payment for transit fare; an application server system associated with the computer application module (APP) and accepting at least a payment, issuing a machine readable fund indicator and a transaction statement; a transit station application module (TSA) associated with application server system capable of being installed on a transit station computer, especially on entry and exit computers, and data-connected to validation terminals at entry and exit gates. The application server system is capable of calculating a transit fare for a journey and deducting the fare from the funds registered on the user account and reissuing the fund indicator and updating the transaction statement on the computer application module (APP).

Typically, the application server system comprises a plurality of servers that are used in combination.

Optionally, the transit station application module (TSA) is integrated with existing Automatic Fare Collection (AFC) system.

The installation procedure for the computer application module (APP) includes downloading the computer application module (APP) over the Internet onto the communication device (mobile telephone) and installing the computer application module thereon. For sake of universality, similar computer application modules (APPs) may be provided for various mobile operating systems, for example iOS®, Android™, Windows®, and like operating systems. Advantageously, the installation procedure of the computer application module (APP) also includes automatically receiving the registered mobile number of the SIM card by the computer application module (APP) and sending the registered mobile number to the application server system. Alternatively, the computer application module (APP) may also prompts the user to type in the mobile telephone number on the keypad of the mobile telephone and sending the registered “mobilenumber1” to the application server system which in turn sends a SMS with an OTP (one time password) to “mobilenumber1” to verify the mobile number.

On receiving the OTP by user input, the computer application module (APP) submits it automatically to the application server system. Upon successful verification of “mobilenumber1”, the application server system automatically activates a first user account.

Upon activating the first user account for the mobile number, the computer application module (APP) on the mobile telephone prompts the user to type an amount of funds to be registered on the user account for automatic payment for transit and select a payment method, for example credit card, debit card, net banking, coupon, or e-wallet, and the corresponding information required to process the payment.

Upon successful payment, the application server system issues a machine readable fund indicator with funds available and a transaction statement to the computer application module (APP).

This is very advantageous, as the passenger will immediately have the funds available for use on the computer application module (APP) without the need to wait and go to the AVM machine to collect funds for use.

Additionally, the computer application module (APP) and application server system may be configured to register funds on the user account by cash at ticket counter or AVM/ticketing machine. Upon machine-reading the fund indicator at the AVM/ticketing machine or entering the mobile number in the AVM/ticketing machine and inserting the cash in the AVM/ticketing machine, the transit station's computer system sends the fund-registration with application server system to register the funds on the user account. This will be advantageous to people who does not have credit card, debit card or net banking facilities.

Optionally, the computer application module (APP) and application server system may be configured to register funds via vouchers, which can be bought at newsagents, supermarkets, or convenience stores. This will be advantageous to decongest ticket counters or AVM/ticketing machines in transit stations.

In further embodiments, the computer application module (APP) and application server system may be configured to register funds on another user account i.e. computer application module (APP) on another mobile telephone with different mobile number.

The computer application module (APP) and application server system may be configured to auto fund-register or prompt the user to fund-register in the event the balance funds available falls below a threshold. This will be advantageous in avoiding denial of service due to insufficient funds and hence cause unnecessary delay/disruption in the journey.

Optionally, the computer application module (APP) and application server system may be configured to buy a season tickets/pass i.e. weekly, monthly, quarterly. This may be advantageous to passengers depending on the transit operator's fare policies.

The computer application module (APP) and application server system may be configured to give discount for student, senior citizen or young person as per transit operator's fare policies. Once the eligible passenger has submitted the required documents for example a photo, a photo ID and user ID on which they wish to get the discount and it is approved, the application server system loads the photo ID of the passenger on the computer application module (APP) of the user and charge the discounted fares to the user account. The validation terminal may be configured to make a different audio signal upon machine-reading the fund indicator at the validation terminal in the case of privilege class. This will help detecting any misuse by fare enforcement staff.

Once the validity of the discount finishes, the application server removes the photo ID from the computer application module (APP) and the passenger will be charged the standard fares.

In further embodiments, the computer application module (APP) and application server system may be configured to issue an additional fund indicator to pay the transit fare for another person improving further user friendliness and versatility of the system. This is very useful for many people traveling with younger or older members of family or friends who do not own a Smartphone.

Upon machine-reading the fund indicator by the validation terminal installed at an entry gate, the entry gate barricade opens for the passenger to enter the station, the transit station's computer system sends the data on the fund indicator to the application server system. The application server verifies the amount on the fund indicator with the actual amount available on the user account and on successful verification sends the entry-registration notification to the computer application module (APP) and updates the transaction statement for immediate feedback to the passenger.

Upon machine-reading the fund indicator by the validation terminal installed at the exit gates, the exit gate barricade opens for passenger to exit the station, the transit station's computer system sends the data on the fund indicator to the application server. The application server system calculates the transit fare for the journey undertaken by the passenger, reissue the fund indicator with balance funds available after deducting the transit fare and updates the transaction statement for immediate feedback to the passenger.

The system and method as presented herein are dynamic and programmable. For example the transit fare is calculated dynamically as per use of the service based on multiple parameters such as the distance travelled, time of the day, the day of the week, time spent, fare capping, and/or maximum penalty fare for incomplete journey.

The immediate feedback is very advantageous, as the passenger will immediately know any over-charge/penalty fare due to out of service/faulty validation terminal and could resolve the issue promptly with transit operator staff.

The transaction statement may provide the complete transaction details for example date and time of each registration, incomplete journey, insufficient funds, type of transit mode for example metro, bus, tram.

The transit station application module (TSA) sends the data on the fund indicator barcode to the application server system immediately and also checks the amount available on the fund indicator. If the amount available on the fund indicator is less than the threshold amount as per transit provider's policies, the entry gate barrier does not open. The application server sends the insufficient-funds notification to the computer application module (APP) and updates the transaction statement.

If the amount available on the fund indicator is greater than the threshold amount as per transit provider's policies, the entry gate barrier opens. The application server system verifies the funds indicated by the fund indicator with the actual amount available on the user account, as some user may not have updated their fund indicator and the actual amount available on user account is below the threshold amount as per transit provider's policies or the amount indicated by the fund indicator. In the event the actual funds available on the user account is less than the funds as indicated by fund indicator, the application server system registers the user ID on the watch list and submits the watch list to all transit station application module (TSA). The application server system sends a notification to the computer application module APP to register more funds on the user account. If the passenger registers sufficient funds before passing through the exit gate, the application server system removes the user ID from the watch list and updates the watch list to all transit station application module (TSA).

Upon machine-reading the fund indicator by the validation terminal at an exit at any station, the transit station application module (TSA) checks whether the user ID on the fund indicator is on the watch list, and in the event the user ID is on the watch list, the barrier gate does not open, preventing the passenger from exiting the station. The application server system sends a notification to the computer application module APP to register more funds on the user account.

In case the fund indicator has not been updated, the passenger will be able to enter the entry station by using the un-updated fund indicator but will not be able to exit the exit station.

The local decision by the transit station application module (TSA) on the transit station computer system at entry and exit gate is highly advantageous to maximise the speed and throughput through the entry and exit gates rather than waiting for a real time response from the application server system, especially during the peak times, without compromising on the security of the system.

As an additional option, the transit station application module (TSA) keeps the list of recent entry-registered and exit-registered user ID for example in last 5 minutes to avoid misuse and unintentional double machine-reading the fund indicator. If the ID data is in a recent entry-registration and exit-registration list, the entry/exit gate barrier does not open.

In an event where the passenger's mobile telephone runs out of battery or gets damaged or lost during the transit, the passenger gives his mobile number to transit operator staff at exit gate. The transit operator staff enters the mobile number of the passenger in the inspection computer application module (INS-APP) and submits it to the application server system. The application server system sends the funds available, fund indicator and entry-registration to the inspection computer application module (INS-APP) to verify it with the passenger. On successful verification, the transit operator staff is exit-registering the passenger by machine reading the fund indicator on the inspection computer application module (INS-APP) by the validation terminal at the exit gate. The application server system reissues the fund indicator with balance funds available after deducting the transit fare, updates the transaction statement in the computer application module (APP) of the mobile telephone of the passenger.

The inspection computer application module (INS-APP) may be configured to machine-read the user ID on the fund indicator through the camera on the mobile telephone on which the inspection computer application module (INS-APP) is installed.

Additionally, as an option, the inspection computer application module (INS-APP) may be configured to authorise a refund of penalty fare/overcharge due to out of service/faulty validation terminals or a charge due to genuine mistake on the part of a passenger. This will be very useful in resolving passenger complaints/issues efficiently and effectively.

The fare enforcement staff can inspect the user account on the computer application module (APP) of the passenger's mobile telephone. In an event that the passenger's mobile telephone runs out of battery or gets damaged or lost during the transit, the fare enforcement staff types the mobile number of the passenger in his inspection computer application module (INS-APP) and submits it to the application server system. The application server system sends the user account details of the passenger to fare enforcement staff's inspection computer application module (INS-APP) to ascertain that the passenger has entry-registered at an entry gate or entry-registered at the start of the journey in case of bus/tram. This will be useful and advantageous for fare enforcement in transit systems with open entry and exit gates.

The computer application module (APP) and application server system may be configured upon user command the request to refund the balance funds available on the user account. For cash refund, the application server system issues a refund code to the computer application module (APP). Upon machine-reading the fund indicator or entering the mobile number and the refund code in the AVM/ticketing machine, the transit station computer system checks the validity of the refund code with the application server system. In the affirmative, the vending machine refunds the cash and the application server system sends the notification to the computer application module (APP) and updates the transaction statement. This will be advantageous to tourists and visitors.

The computer application module (APP) and application server system may be configured to transfer balances from the user account to another user account on associated with a different mobile number, thereby improving further user friendliness and versatility of the system.

In the event that the mobile telephone is damaged or lost, the balance funds available on the user account will be available on the computer application module (APP) on a new telephone with the same telephone number.

The application server system may provide transit-related information to a passenger, for example, by sending the information to the computer application module (APP). The application server system may notify a passenger about delays due to signal failure or some other reasons on certain routes, planned maintenance/engineering works. The application server system may provide the information to a passenger upon request from the passenger.

The system for electronic fare collection of the present invention has many advantages for all parties involved, i.e. user, transit operator and government agency. For example, for the user of the system does not need a physical card, reduced operation and inventory cost, as the transit operator does not need to issue and process cards, and visitors can arrive in a city from anywhere in the world and travel using the mobile APP. Moreover, the system for electronic fare collection of the present invention allows immediate transparency to the passenger on every activity on the account. Further, the system for electronic fare collection of the present invention provides multiple payment options, which are well known to the public and widely used in ecommerce transaction enhancing further the user friendliness and versatility of the system. The main advantage for the transit operator is that the system for electronic fare collection of the present invention does not require large investment for expensive additional hardware, reduces the cost of operations and decongest transit stations at minimum cost/investment. The main advantage for the government agency is that the system for electronic fare collection of the present invention allows complete transparency, tourist friendly and decongestion of the transit stations. The convenience, low cost of implementation and reduced operations' costs offered by the present invention ensure widespread acceptance by all parties involved.

According to exemplary embodiments of the present invention, the functions/features as described above are achieved by proper programming of the application server system, the computer application module (APP), and connection with transit station computer system. In particular, the computer application module (APP) is programmed, as part of the installation procedure of the computer application module (APP), for receiving the telephone number of the SIM card by the computer application module (APP) and sending the telephone number to the application server system associated with the computer application module (APP) in order to activate a user account by the application server system. Upon account activation, the computer application module (APP) is programmed to prompt the user to type the amount of funds to be registered on the user account for automatic payment of transit fare on the computer application module (APP) and select a payment method. Upon user command and request, the computer application module (APP) is programmed to submit amount of funds to be registered and the selected payment method to the application server to process the payment. Upon successful payment, the application server issues a machine readable fund indicator and a transaction statement to the computer application module (APP). Upon machine-reading the fund indicator by the validation terminal installed at an entry gate, the entry gate barricade opens for the passenger to enter the station. The transit station computer system sends the data to the application server system which sends the notification to the computer application module (APP) and updates the transaction statement. Upon machine-reading the fund indicator by the validation terminal installed at the exit gates, the exit gate barricade opens for the passenger to exit the station. The transit station computer system sends the data to the application server. The application server system calculates the transit fare for the journey undertaken by the passenger, reissues the fund indicator with balance funds available after deducting the transit fare, and updates the transaction statement to computer application module (APP).

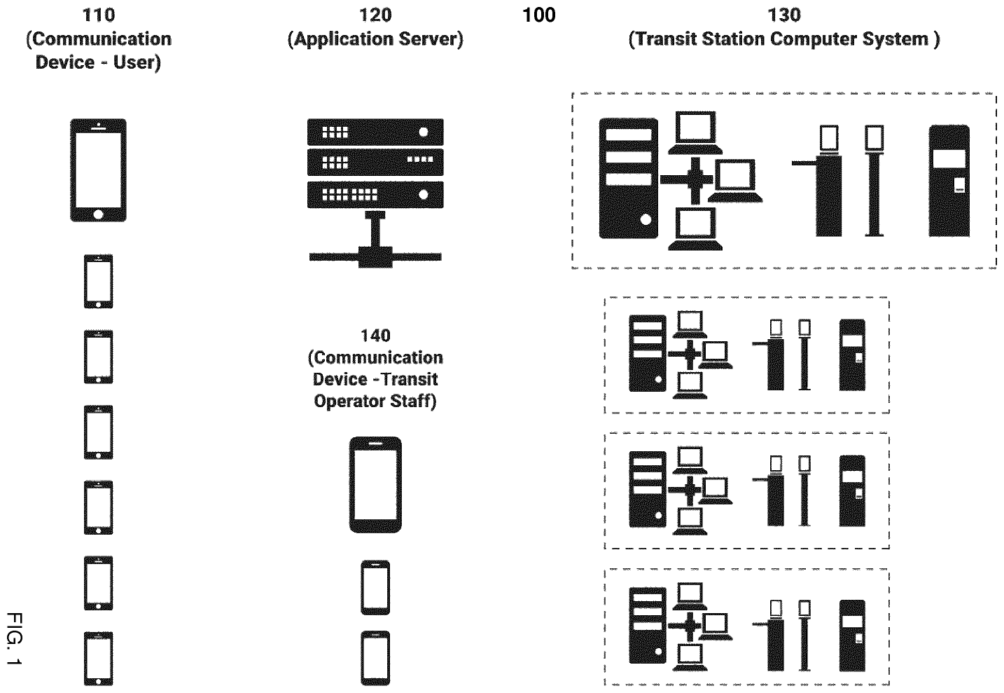

FIG. 1 is a schematic illustration of a system 100 for an electronic fare collection, according to an exemplary embodiment. The system 100 includes a plurality of communication devices 110, wherein each of the devices 110 belongs to a passenger of an electronic fare collection service provided by the system 100. Examples of communication devices 110 include mobile telephones, personal computers (PC), mobile computers, or any other device able to operate the computer application module (APP). The plurality of devices 110 have connectivity capability and are configured for communication with the application server system 120, for example by a cellular network or wireless network or other type of mobile communication means.

The system 100 includes a plurality of transit station computer systems 130. The transit station computer system may constitute multiple for example validation terminals, AVM/ticketing machines, inspection terminals, multiple computers, including entry and exit computers, such as laptops, servers and other suitable peripherals such as are image scanners, barcode reader, digital cameras, able to include, receive and manipulate and/or operate opening and closing of entry and exit gates.

The plurality of transit station computer systems 130 has connectivity capability for example by a telecommunication networks, a wireless network or a cellular network or a satellite network or any other communication means.

The system 100 includes a plurality of communication devices 140, each of the devices 140 may belong to a transit operator staff. The communication devices 140 include, for example, mobile telephones, personal computers (PC), mobile computers or any other suitable devices able to include, receive and manipulate and operate the inspection computer application module (INS-APP). The plurality of devices 140 has connectivity capability and for communication with the application server system 120, for example, by a cellular network or wireless network or any other mobile communication means.

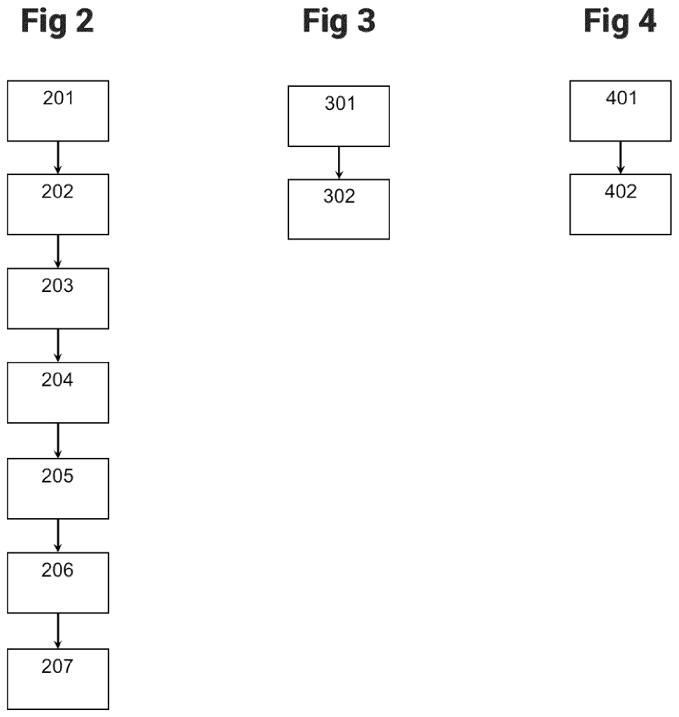

FIG. 2 is a flow chart of a method 200 for an automatic payment of a transit fare from the communication device, for example smartphone. The method 200 comprises a plurality of stages including a stage 201 to a stage 207.

At the stage 201, the communication device, for example a mobile telephone, such as a smartphone, of a first user is provided with a SIM card inside, having a first registered telephone number “mobilenumber1”. The computer application module (APP) is downloaded, with an appropriate APP distribution service for example PlayStore™ for Android and AppStore™ for iOS, through the Internet onto the mobile telephone and installed thereon.

At the stage 202: as part of the installation procedure, the computer application module (APP) receives “mobilenumber1” from the SIM card, either automatically or by user input, and submits it to the application server system.

At the sage 203: the application server system sends an SMS with an OTP (one time password) to “mobilenumber1” to verify the mobile number. On receiving the OTP by user input, the computer application module (APP) submits it automatically to the application server system.

At the stage 204: upon successful verification of “mobilenumber1”, the application server system automatically activates a first user account.

At the stage 205: upon activating the first user account, the computer application module (APP) on mobile telephone prompts the user to type the amount of funds to be registered on the user account for automatic payment of transit fare and select a payment method.

At the stage 206: upon user command and request, the computer application module (APP) sends the application server system the amount of the funds to be registered and the selected payment method to process the payment.

At the stage 207: upon successful payment, the application server system issues a machine readable fund indicator with available funds and a transaction statement to the computer application module (APP).

FIG. 3 is a flow chart illustrating the stages/steps 301 and 302 for machine reading the fund indicator by the validation terminal at entry and exit gates and automatically deducting the transit fare from the user account of the passenger.

At the stage/step 301: Upon machine-reading the fund indicator by the validation terminal installed at an entry gate, the entry gate barricade opens for passenger to enter the station, the transit station computer system sends the data on the fund indicator to the application server system. The application server verifies the funds indicated by the fund indicator with the actual amount available on the user account and, on successful verification, updates the transaction statement for immediate feedback to the passenger.

At the stage 302: Upon machine-reading the fund indicator by a validation terminal installed at the exit gate, the exit gate barricade opens for the passenger to exit the station, the transit station computer system sends the data on the fund indicator to the application server. The application server system calculates the transit fare for the journey undertaken by the passenger, reissues the fund indicator with balance funds available after deducting the transit fare, and updates the transaction statement for immediate feedback to the passenger.

FIG. 4 is a flow chart illustrating the stages/steps 401 and 402 for inspecting the user account of the passenger on the inspection computer application module (INS-APP) and exit-registering the passenger by the transit operator staff.

At the stage 401: The transit operator staff types the mobile number of the passenger for reading by the inspection computer application module (INS-APP) and causes it submitted to the application server system. The application server system sends the fund indicator with funds available and entry-registration details of the passenger to the inspection computer application module (INS-APP) to verify the detail with the passenger.

At the stage 402: On successful verification, the transit operator staff is exit-registering the passenger by machine-reading the fund indicator, as displayed on the inspection computer application module (INS-APP), by a validation terminal at an exit gate, and the exit gate barricade opens for the passenger to exit the station. The application server system reissues the fund indicator with balance funds available after deducting the transit fare, updates the transaction statement to the computer application module (APP) of the passenger.

1. A method of collecting travel fares in a transport system, wherein the transport system comprising multiple departure locations with multiple destinations and with a variable fare system in which a fare is dependent on the distance between a departure location and a destination; wherein each departure location comprises an entry gate system with at least one entry gate and at least one local entry computer, and each destination comprises an exit gate system with at least one exit gate and at least one local exit computer; wherein each of the entry gates is provided with entry validation terminal data-connected to the at least one local entry computer, and each of the exit gates is provided with an exit validation terminal data-connected to the at least one local exit computer; and wherein the transport system is configured for registering a passenger's passage through the entry gate and exit gate by the corresponding validation terminals for calculating the fare for the distance of the passenger's travel from the departure location to the destination and charging the passenger for the fare;
wherein the method comprises:
providing a computer application, APP, and submitting it to at mobile telephone of the passenger and installing it, wherein the mobile telephone comprises a SIM card with a telephone number; the APP being programmed for registering prepaid funds that are available on a user account of the passenger for covering automatic collection of the fare; wherein the APP is programmed to display a machine readable fund indicator on the display of the mobile telephone, the fund indicator indicating the remaining funds on the user account;
providing an application server system associated with the APP and causing the APP to submit ID data of the mobile telephone, the ID data including the telephone number, from the APP to the application server system and by the application server system creating a user account and associating the ID data with the user account;
by the application server system registering collection of prepaid funds into the user account prior to collection of the fare and sending corresponding data to the APP for registration of the available prepaid funds by the APP and indicating the funds by the fund indicator;
providing a data connection between the application server system and the entry and exit computers for exchange of passenger-related data between the application server system and the entry and exit computers;
wherein the method comprises as part of the passenger's travel
at the entry gate for the passenger, by the entry validation terminal machine-reading the fund indicator on the display of the mobile telephone as part of an entry registration of the passenger;
evaluating at the passenger's entry gate by the entry computer whether the fund indicator indicates funds above a predetermined threshold and allowing the passenger to pass the entry gate only in the case that the threshold is met; in the event of the threshold not being met, preventing the passenger to pass the entry gate and submitting data from the fund indicator, as machine-read at the entry gate, from the at least one entry computer to the application server system and by the application server system causing the APP to indicate to the passenger to register more funds in order to pass through the entry gate; in the event of the threshold is being met, as a control measure, only after entry of the passenger through the entry gate, exchanging data with the application server system and by the application server system checking whether available funds on the corresponding user account as registered by the application server system actually meet the threshold, and if the funds registered as available on the corresponding user account do not meet the threshold, despite the indication of sufficient funds by the fund indicator, registering the associated ID data in a watch list; submitting the watch list from the application server system to all exit computers;
at the exit gate for the passenger, by the exit validation terminal machine-reading the fund indicator on the display of the mobile telephone as part of an exit registration of the passenger; checking the watch list by the exit computers at the passenger's exit gate for ID data for the passengers passing the exit validation terminal and preventing the passenger to pass through the exit gate if the watch list contains the ID data; and submitting data from the fund indicator, as machine-read at the exit gate, from the at least one exit computer to the application server system;
by the application server system, on the basis of the data received from the entry and exit computers, calculating a fare for the travel between the passenger's entry gate and the exit gate and deducting the fare from the available funds in the corresponding user account,
submitting data for available remaining funds in the corresponding user account from the application server system to the APP, registering the funds by the APP and on the display of the mobile telephone indicating the remaining funds by the fund indicator.

2. The method according to claim 1, further comprises:
providing an inspection terminal with a data connection to the application server system; the inspection terminal being configured for receiving a telephone number by manual input on a keypad or touchpad of the inspection terminal or by voice recording with speech recognition;
by control-personnel operating the inspection terminal;
by the inspection terminal receiving the passenger's telephone number from manual input or voice recording and submitting it to the application server system;
by the application server system checking the available funds on the corresponding user account and checking whether the ID data have been received by the application server system from an entry computer as a confirmation of the entry-registration at an entry validation terminal at the start of the passenger's travel from a departure location;
by the application server submitting an indication of the available funds back to the inspection terminal as well as an entry-indication of an entry-registration or lack thereof;
displaying the available funds and the entry-indication on a display of the inspection terminal;
by the control-personal checking the displaying of the available funds and the entry-indication on the display of the inspection terminal and allowing the passenger to pass the exit gate only if the indicated available funds meet a predetermined threshold and only if an entry-registration is confirmed by the entry-indication;
after the passage of the passenger through the exit gate, submitting a confirmation of the passenger's exit to the application server system.

3. The method according to claim 2, further comprises:
providing an inspection terminal with a data connection to the application server system; the inspection terminal being configured for machine-reading the fund indica tor on the display of the passenger's mobile telephone;
by control-personnel operating the inspection terminal;
by the inspection terminal machine-reading the fund indicator, extracting the ID da ta, and displaying the funds from the fund indicator on a display of the inspection terminal, submitting the Id data to the application server system;
by the application server system checking the available funds on the corresponding user account and checking whether the ID data have been received by the application server system from an entry computer as a confirmation of the entry-registration at an entry validation terminal at the start of the passenger's travel from a departure location;
by the application server system submitting an indication of the available funds back to the inspection terminal as well as an entry-indication of an entry-registration or lack thereof;
displaying the available funds and the entry-indication on a display of the inspection terminal;
by the control-personal checking the displaying of the available funds and the entry-indication on the display of the inspection terminal and allowing the passenger to pass the exit gate only if the indicated available funds meet a predetermined threshold and only if an entry-registration is confirmed by the entry-indication;
after the passage of the passenger through the exit gate, submitting a confirmation of the passenger's exit to the application server system.

4. The method according to claim 2, wherein the inspection terminal is a hand-held inspection terminal comprising a further mobile telephone provided with an inspection computer application, INS-APP, associated with the application server system, the INS-APP being programmed for communication with the application server system and for receiving and displaying the indication of the available funds as well as the entry-indication and the fund indicator on a display of the further mobile telephone,
by the control-personal causing the exit validation terminal to machine-read the fund indicator as displayed on the hand held inspection terminal and letting the passenger pass the exit gate only if the indicated available funds meet a predetermined threshold and only if an entry-registration is confirmed by the entry-indication.

5. The method of claim 1, wherein the fund indicator comprises a barcode, wherein data for the available funds and the ID data are indicated by the barcode.
